(19) United States
(12) Patent Application Publication
(10) Pub. No.: US 2004/0060107 A1
(43) Pub. Date: Apr. 1, 2004

(54) Individually adjustable, automated, whole-body washing apparatus

(76) Inventor: David Eisenberg, Jerusalem (IL)

Correspondence Address: David Klein, Dekel Patent, Beit Harof im Room 27, 18 Menuha VeNahala Street, Rehovot, 76209, IL

(21) Appl. No.: 10/466,286

(22) PCT Filed: Jan. 15, 2002
(86) PCT No.: PCT/IL02/00034

(30) Foreign Application Priority Data
Jan. 16, 2001 (IL) 140923

(51) Int. Cl. A47K 3/02

(52) U.S. Cl. 4/605; 4/564.1

(57) ABSTRACT

An individually adjustable, automated, washing apparatus, including: a controller arranged for receiving input to a program of at least two steps, respectively having a plurality of variables, and the controller transforms the input into a series of control signals; (B) a wash structure held by a support construction, and the wash structure includes a surface, in contact with a portion of a person to be washed, and this surface has a first system of running water and tactile stimulus members, and the first system is imbedded in said surface, and is in communication with a water source, and is responsive to the signals; and (C) at least one driver of motion of the members, and the at least one driver is driven by at least one item selected from the list: electromechanical motors, water pressure, air pressure, and a pressurized air-water-mixture.

### FIELD OF THE INVENTION

The present invention relates generally to adjustable washing apparatus. The present invention relates in particular to personal washing apparatus which is automatically adjustable, to suit individual needs and desires.

### BACKGROUND OF THE INVENTION

The existence, in most modem homes, hotels, hospitals and many other institutions, of bathing and showering as well as ablution facilities is quite commonplace. Many such facilities cater, at least in part, for elderly or handicapped people. However, unless specificaly designed and constructed for specific handicaps or for elderly people with-particular physical problems, most modem bathing, showering and ablution installations fall far short of being at least adequate for people of special needs.

Except in specially constructed old-age homes and the like, provision for the elderly and handicapped is woefully inadequate. Presumably, economics, space and forethought all contribute to this inadequacy. The existence of well designed and constructed bathing, showering and ablution equipment for elderly and handicapped people is not plentiful.

There are a number of patents for a variety of aids for showering and even showering and massaging. Some of these provide concepts, which, although not specifically for assisting both elderly and handicapped people, do provide some assistance. U.S. Pat. No. 4,274,400 describes a massage shower having a guide rail provides for a massage shower with a massage; head for delivering service water. The shower is mounted on a vertical guide rail, so that it can be moved upward or downwards along the guide rail and fixed in a suitable position. The showerhead is driven and controlled in a longitudinal direction on the guide rail by the service water.

U.S. Pat. No. 4,640,462 describing a water driven shower massager provides for a handheld water driven shower massager unit which has a housing with a rotatable nozzle rotates by the high velocity discharge rate of water from the nozzle. An oscillating or vibrating motion is achieved by eccentrically weighting the rotating water discharge nozzle, which then provides a massaging effect when pressed against the user. Held away from the user, the unit functions as a shower unit. Varying the flow rate of water and changing the nozzle configuration, or the angle of water discharge from the nozzle, performance and characteristics of the unit can be modified. Cleansing and massaging pads can be attached to the unit as needed by the user. Another devise described in U.S. Pat. No. 4,651,720 for a massaging and showering assembly provides for a massaging and showering assembly made up of a guide rail along which a carriage with a massage and shower head that can be moved vertically. A water flow reversing control-unit and a piston-cylinder arrangement connected to a water line communicates with the carriage. In contrast to earlier assemblies, this assembly can be produced at low cost, and is light and compact, but highly reliable and stable.

U.S. Pat. No. 5,105,484 describes a back scrubber device mounted in a shower stall or on the wall of a bathtub, which includes a U-shaped back scrubber bar having the central portion connected to a wall support mounting bracket. The spaced portions of the bar are sufficiently spaced to fit a person in between. A scrubber is attached at one end of the spaced leg portion and the other spaced leg portion is a handle. The scrubber is movable in an up and down motion to scrub a person's back through movement of the handle by the person standing between the two spaced leg portions of the back scrubber bar. A further development described in U.S. Pat. No. 5,345,640 is a motorized back scrubber for the back of an individual. The scrubber includes various rotating brushes driven by an electric motor. The device may be mounted on a shower or bath wall by suction cups provided. A soap dispenser provides soap to the center area of each of the brushes and a water supply assembly provides water for rinsing a user's back.

A number of other devises are described showing additional features for providing much the same type of facility. U.S. Pat. No. 5,418,985 for a massage shower system describes a massage shower system which includes injectors for directing jets of water, or air and water, under pressure, sprayed radially towards a person standing up within the frame. The injectors are supported on a frame and an actuator for communicating a vertical reciprocating movement to the frame with respect to the patient. The frame moves, at varying speeds, between a low and an upper position along the vertical direction. U.S. Pat. No. 5,517,705 specifies a back scrubbing device for fastening to a shower wall, which includes a main housing with front and rear walls, opposing side walls and top and bottom walls. The front wall has perforations and the top and bottom walls each have a water connection. A water supply hose is connected to the opening in the bottom wall of the main housing and the other to a shower head or bathtub faucet to supply water to the device. A brush is fastened to the front wall of the main housing and has a number of openings. The openings in the brush are aligned with the perforations in the front wall of the main housing so that water can pass through. A liquid soap container is mounted to the main housing. The container includes a dispenser extending from the top wall of the housing for dispensing liquid soap.

U.S. Pat. No. 5,675,846 depicts devices of the brush-massage shower installation which lets a person be massaged with selected skin-friendly bristles of a dry or water-spraying and wet-cleaning rotating massage roller. The brush-massage shower installation allows freedom in the selection of the driving elements. A water turbine gear, driven by the pressurized water supply, is the infinitely variable drive of the water-spraying rotating massage roller. A variable speed gear motor, the design of which is kept flat and is electrically protected, drives the dry-running rotating massage roller. The motor is located in the outer bath side wall, from where it drives the electrically protected gear connected to the inner wall side for rotating the massage roller.

U.S. Pat. No. 5,774,907 describes a shower wall back scrubber and massager attached to a wall of a shower and connected to the shower head. This showerhead cleans and massages the back of the person that makes contact with the showerhead. The massager includes a pad, attaching apparatus, connections, and cleaning and massaging apparatus. The pad is attached to the wall of the shower, in contact by the person showering. The attaching apparatus attaches the pad to the wall of the shower so as to allow the shower wall back scrubber and massager to be attached to the wall of the shower when needed. The fluid connection via the pad to the head of the shower allows the shower wall back scrubber and massager to be connected to receive water and cleans and massages the anyone making contact with the pad.

While each of these devices or systems do provide a measure of assistance to the user, and are usable by an elderly or handicapped to some advantage, these do not really enable such users to be either assisted or remain in a seated position without some significant assistance. There are some patents relating to devices and systems that are more specifically designed to cater for the needs of elderly and handicapped people.

One of these is U.S. Pat. No. 4,398,789 for an opto-electronically controlled bathing systems for use with bathing systems with electronic and optionally microcomputer control of optionally multiple functions, user safety is assured by fiber-optic techniques. Electrically safe optical controls are positioned in or near the bathing location. This location can include a swimming pool, bathtub, whirlpool bath, shower, bidet, or similar installation. Devices such as valves, pumps, pulsation devices, water conditioning devices, and the like are controlled by a single electronic controller responsive to the optical control at the bathing location, and also to various water condition sensors. The optical controllers include a light adjuster, preferably an optical touch switch operated by light reflected from the user's finger. Connection by fiber optic cable to a remote light source and detector may also include a display such as optical fibers or fiber bundles carrying light from remote light sources indicating water or other conditions to the electronic controller. The electronic controller preferably includes a microcomputer because of the ease of use to monitor many input variables and produce many output functions. For simplicity of installation, fiber optic cable can be incorporated into the plastic water piping.

Furthermore, U.S. Pat. No. 4,680,817 describes a compact personal hygiene center includes a tub, hand-held showerhead and toilet. The tub is enclosed with front, rear and end walls and a ceiling and an entrance in the front wall. The door closes off a lower portion of the front wall to contain water in the tub and to permit access into the tub by an attendant. A bench-style seat is integral with the end wall. There is a cavity beneath the seat exposing a major portion of an edge of the seat adjacent to the front wall, and another opening in the front wall for sliding the toilet into and out of the cavity on tracks provided. The toilet, when outside of the front wall provides a transfer for moving a person from outside the tub through the opening onto the bench seat. The hand-held showerhead mounted on the other end wall, connected by a flexible hose, extends the hand-held shower over to the toilet. This system provides the means for assistance to a user who requires substantial help but is not particularly useful for an unaided patient. All the washing would need to be carried out manually.

U.S. Pat. No. 5,335,378 provides for an automatic bathing apparatus which includes a lifting mechanism to carry a revolving sponge cylinder, water spray pipe and massager up and down on upright racks inside a housing. In addition, there are a concealable slidable sink and water tap inside the housing, two revolvable auxiliary sponge cylinders mounted lower outside the housing, an internal shower at the top, an external shower above the auxiliary sponge cylinders, a tooth mug holder and a dryer on the housing on the outside. While this system provides a degree of automation in the washing procedure, there are a number of disadvantages. A user would need to stand or sit up against the rollers which would only wash the relatively flat areas of the body. Crevices and relatively concealed body parts would remain unwashed. The neck, crutch, underarms and feet are not really provided for by this invention.

U.S. Pat. No. 5,652,976 describes a prefabricated modular invalid bathroom unit for installation in a room. The unit has a shower seat, a shower floor adjacent the shower seat for draining shower water, a removable upper shower wall mounted on the shower seat portion which acts as a splash back surround opposite the shower floor, and a commode for receiving a toilet. The shower floor is accessible by wheelchair. Water supply pipes and drain pipes are connected with conventional plumbing connectors. Each modular portion can pass through a standard door opening for access into a home. A template is also provided for locating and fastening to the room floor and for also providing a plumbing template. This invention provides a facility for an attendant to wash an invalid but a significant amount of manual washing is necessarily required as well as the manhandling of the invalid. Also, many invalids could not make self-use of this facility without substantial assistance.

Similarly, U.S. Pat. No. 5,742,956 for a modular bathroom unit, includes a commode, shower with floor drain, and a relatively large lavatory, configured to pivot vertically when not in use, or horizontally for use. The drain connection system is unique. The lavatory drain includes a drainpipe connection to a stationary drainpipe built into the wall of the unit, the connection accomplished without hoses, pipe fittings or the like. The shower and toilet facility is configured to be watertight, with a sealed door, and an easily cleaned interior surface. The unit can be fabricated as a one-piece, molded fiberglass unit, although other methods may also be employed. This may be utilized as a stand alone, portable bathroom facility, or as a space saving bathroom, in a building, a camper, boat, modular housing or the like, wherever a small, full-featured bathroom is desired. Again this invention provides a facility rather than the means for dealing with cleaning a patient or handicapped person.

U.S. Pat. No. 5,978,983 describes a portable showering cabinet for use by disabled, aged, or other persons. This cabinet is designed for persons unable to use conventional showering and toilet facilities, for use in a private home, hospitality industry, residential schools, general and specialized hospitals, rehabilitation centers, and bedside care in a nursing home, with minimal or no assistance. This eliminates the need to help a disabled person enter a shower stall and the need for a caregiver to perform the showering of the individual. The portable cabinet includes a water supply attached to existing hot and cold water supplies. A manually movable cabinet that has casters, can be moved easily and quickly along a floor surface to a bedside, with improved access seat to insure safe entrance by the patient into and out of the enclosure from a seated position on the outside of the cabinet. Also, a door for users of the cabinet includes a wrap around member that securely and conveniently encloses the cabinet when the door is closed. The major advantages of this cabinet is the fact that a patient need not be moved to a bathroom facility and allows for full body showering. However, an attendant would need to do the actual washing of the patient's entire body prior to showering with water. Access to all the patient's body parts for manually washing is not easy with this cabinet.

There are a number of inventions that relate to devices for washing the genital area in much the same way as a conventional bidet. For example, U.S. Pat. No. 5,159,722 describes a drive for a shower arm of a bidet device. A shower arm drive for a bidet has a shower arm, a lever type drive, a piston cylinder, and a water distributor fastened on a support plate. The shower arm is extended by actuating a pressure switch, to pressurize the piston cylinder connected to the water mains. The piston is pushed forward against a compression spring and the shower arm extends. A control valve regulates a spray of warm shower water from the shower arm nozzle. The drive is compact and can be installed in a water closet lid.

A similar device is depicted in U.S. Pat. No. 5,230,107 for multipurpose bath apparatus. In this case, a portable bidet seat is supported by one side of a bathtub and by a pipe secured to a wall on the opposite side of the bathtub. A pair of additional pipes traverse within this pipe, one of which directs tap water from the bathtub faucet to the bidet unit. The other pipe couples to a whirlpool system for the bathtub. In addition, the first pipe may be perforated and also coupled to the faucet to provide a sideways directed shower flow.

U.S. Pat. No. 5,581,825 describes a bidet shower seat for washing lower and upper portions of a human body. This includes a stool upon which an individual can sit. An interior bowl of the stool has spray nozzles for directing water to the genital region of the user. An extendable spray nozzle mounted to the stool can be used to selectively shower the body of the user. A chair can be placed over the stool to support the user above the stool during a bathing procedure. This device is another which requires washing of the patient by an attendant and merely provides water spraying where and when needed.

U.S. Pat. No. 5,943,707, which describes a shower device for a toilet seat, includes a shower head, a water supply, and a carrier on which the shower head and part of the conduit are arranged. The shower head can be pivoted horizontally about a vertical axis between an active position for giving a person sitting on the toilet seat a shower from beneath in his or her seat region, and an inactive position in which the shower head is moved aside. This invention is a useful attachment to a conventional toilet for spraying water on to the genital and anal area.

Generally for applications where people go barefoot, for example, into a swimming pool area or into a gymnasium, U.S. Pat. No. 5,173,972 describes an automatic foot washer for use on a walkway surface. The washer includes, a hollow frame structure and a valve assembly connected to the hollow frame structure, which extends into the hollow inner space. Also there are both a supply connector for connection to a pressurized water source and a flexible valve hose. A grated actuating platform within the central open area rests partially on the walkway surface. An actuator lever is mounted to the actuator platform and when a person steps on the actuator platform, opens the valve and allows water into the hollow inner space and to the spray outlets causing water to spray through the spray holes in the grated actuating platform onto a person's feet, ankles, and calves. Addition of either soap or disinfecting chemicals to the spray water provides a simple way of respectively cleaning feet and ankles or preventing the spread of foot infections.

U.S. Pat. No. 5,522,552 describes a water play toy the mechanism would also be usable as a foot cleaner/sterilizer. The water play toy includes a base and a platform pivotally mounted on the base so as to be stepped on and pivoted. Several pairs of valves and nozzles are provided around the periphery of the toy between the platform and base so that each valve can be depressed by the platform. The spacing of the pivot points enables eight primary axes over which the platform will pivot to open one or more adjoining valves at the same time. Standing on the central area of the platform, it is depressed vertically and all four valves are depressed and open. Supporting the platform directly on the pivot members before activation can prevent this.

Several of the inventions described heretofore provide systems or devices having limited application for washing of elderly or incapacitated invalids. However, there seems to be a lack in the art for providing more fully for the washing of such people. Most especially, elderly or incapacitated people living alone who have to adequately wash themselves, will find that this is not fully facilitated by available devices.

### SUMMARY OF THE INVENTION

The preferred embodiments of the present invention relates to an individually adjustable, automated, washing apparatus, for use on a whole human body, a side of the whole human body or a body part; such as (for example) the scalp or the back, or a leg.

The preferred embodiment apparatus firstly includes a controller that is arranged for receiving input. The input is selected from analog input or digital input or mechanical input or a combination of variables or at least one predetermined menu selection. Collectively, the input relates to a program of at least two steps each having a plurality of variables and expressing thereby aspects concerning individual form, needs and desires; such as temporal aspects of each step, frequency aspects of any variable within a step, cyclic aspects of any step or plurality of steps, and aspects of temperature preference and temperature limits. These inputs thereby comprise a characterization of a person whose body or body part is to be washed, and the controller transforms, convolves, or processes the input into a series of control signals. Furthermore, the input relates to elective aspects of water use, to occasional additions such as soap, conditioner, oils, perfumes, mixtures with air, etc. Additionally, the inputs relate to aspects of kinematics for tactile members of the apparatus; wherein such tactile members may include rollers, brushes, finger-like projections (“nipples”), or to the operational pressures of water, air or other mixtures as they are forced out from nozzles—and are thereby performing tactile stimulus functions. In addition, the inputs relate to absolute limitations so as to preclude the controller from configuring a combination of variables that is liable to injure or otherwise adversely wash or stimulate the human body or body part intended for washing.

The preferred embodiment apparatus secondly includes a wash structure, held by a support construction. More specifically, the wash structure includes a surface, in contact with a portion of the whole body or body part to be washed; and this surface has a first system of running water and tactile stimulus members (e.g. rotating or fluctuating or with external lateral motion brushes, or rollers, finger-like projections, or to the operational pressures of water, air or other mixtures as they are forced out from nozzles—and are thereby performing tactile stimulus functions). This first system of water and tactile stimulus members is imbedded in Said surface, in communication with a water source, for washing the portion of the body in contact with said surface, and the first system is responsive to the signals. Furthermore, the motion of the members is driven by electromechanical motors, or water pressure or air pressure, or a pressurized air-water-mixture. The wash structure preferably includes a drive, for automatically adjusting said wash structure, responsive to signals from said controller. In that the wash structure may never perfectly conform to the shape of the whole body or body part to be washed, realistically, there may be a second system of running water and tactile stimulus-like members (typically rotating brushes or the likes—as herein-above listed) that do not partake in body contact, and which are likewise anchored against said wash structure, in communication with a water source, for washing the portions of the body not in contact with said surface.

It is an aim of the present invention to provide a personal whole-body washing apparatus which is automatically adjustable, to suit individual needs and desires; wherein the apparatus may be a combination of modular washing units—which may also be used individually or in less than whole-body combinations. Hereinafter, the expression “whole-body” relates substantially to the whole body-surface that is being washed or otherwise stimulated by the apparatus of the present invention.

There is thus provided, in accordance with a typical embodiment of the present invention individually adjustable, automated, whole-body washing apparatus, which includes: a controller, arranged for receiving input concerning individual form, needs and desires of a person whose body is to be washed and for processing said input; a wash structure, held by a support construction, said wash structure including: a drive, for automatically adjusting said wash structure, responsive to signals from said controller; a surface, in contact with a portion of the body to be washed; and a first system of running water and tactile members (hereinafter “rotating brushes”), imbedded in said surface, in communication with a water source, for washing the portion of the body in contact with said surface; and a system of running water and rotating brushes (or other tactile-type stimulus members), anchored against said wash structure, in communication with a water source, for washing the portions of the body not in contact with said surface.

Additionally, in accordance with the present invention, said apparatus is portable, and is arranged to be folded into a carrying box.

Additionally, in accordance with the present invention, said wash structure automatically adjusts to an arrangement selected from a group which consists of: a generally vertical arrangement, for washing the body of the person, standing against it; a bed-like arrangement, for washing the body of the person, lying on it; and a chair-like arrangement, for washing the body of the person, sitting on it.

Additionally, in accordance with the present invention, said apparatus includes electronically controlled valves automatically prevent washing by said first and second systems above a certain height in relation to the height of the person responsive to input from an optical sensing system with regard to the height of the person.

Additionally, in accordance with the present invention, said wash structure is arranged in a generally vertical arrangement, for washing the body of the person, standing against it.

Alternatively, said wash structure is arranged as a bed-like arrangement, for washing the body of the person, lying on it.

Alternatively, said wash structure is arranged in a as a chair-like arrangement, for washing the body of the person, sitting on it.

Additionally, in accordance with the present invention, said apparatus further includes a bidet.

Additionally, in accordance with the present invention, said wash structure further includes a back support.

Additionally, in accordance with the present invention, said wash structure further includes a leg support.

Additionally, in accordance with the present invention, said wash structure further includes a feet support.

Additionally, in accordance with the present invention, said wash structure further includes a head support.

Additionally, in accordance with the present invention, said head support further includes a shampooing system.

Additionally, in accordance with the present invention, said head support further includes a head blow-drying system.

Additionally, in accordance with the present invention, said first system of running water and rotating brushes includes both water nozzles and rotating brushes.

Additionally, in accordance with the present invention, said first system of running water and rotating brushes is arranged to rotate the brushes by the force of the running water.

Additionally, in accordance with the present invention, said first system of running water and rotating brushes further includes a system of rotating rollers for massaging the portion of the body in contact with said surface.

Additionally, in accordance with the present invention, said first system of running water and rotating brushes further includes a warm-air blower for drying the portion of the body in contact with said surface.

Additionally, in accordance with the present invention, said controller is arranged for controlling the temperature of the warm air, responsive to said input.

Additionally, in accordance with the present invention, said second system of running water and rotating brushes includes both water nozzles and rotating brushes.

Additionally, in accordance with the present invention, said second system of running water and rotating brushes is arranged to rotate the brushes by the force of the running water.

Additionally, in accordance with the present invention, said second system of running water and rotating brushes further includes a warm-air blower for drying the portion of the body in contact with said surface.

Additionally, in accordance with the present invention, said controller is arranged for controlling the temperature of the warm air, responsive to said input.

Additionally, in accordance with the present invention, said second system of running water and rotating brushes has a retracted position, for allowing the person to arranged himself against said surface, and a deployed position, in which said second system of running water and rotating brushes generally surrounds the person.

Additionally, in accordance with the present invention, said second system of running water and rotating brushes includes multiple arms arranged along the length of the person.

Additionally, in accordance with the present invention, said second system of running water and rotating brushes is arranged on at least one bar which is moved along the length of the person.

Additionally, in accordance with the present invention, said controller is arranged for controlling the temperature of the water of said water source, responsive to said input.

Additionally, in accordance with the present invention, said apparatus includes a liquid-soap source, in communication with said water source.

Additionally, in accordance with the present invention, said controller is arranged for receiving said input concerning individual needs and desires of the person, from at least one media selected from the list: a smart card; by voice commands; from a touch display panel, displaying a menu; by key strokes.

There is thus also provided, in accordance with the present invention, a method of washing a whole body portion of a person, which includes the steps of: receiving input concerning individual form, needs and desires of the person; processing said input; producing signals which correspond to said input; automatically adjusting individually adjustable, whole-body washing apparatus, responsive to said signals; and washing the whole body portion of the person in accordance with said input.

Additionally, in accordance with the present invention, said step of automatically adjusting individually adjustable, whole-body washing apparatus, responsive to said signals includes automatically adjusting said apparatus to a generally vertical structure.

Alternatively, said step of automatically adjusting individually adjustable, whole-body washing apparatus, responsive to said signals includes automatically adjusting said apparatus to a bed-like structure.

Alternatively, said step of automatically adjusting individually adjustable, whole-body washing apparatus, responsive to said signals includes automatically adjusting said apparatus to a chair-like structure.

Additionally, in accordance with the present invention, said step of automatically adjusting individually adjustable, whole-body washing apparatus, responsive to said signals includes automatically adjusting to the height of the person's head.

Additionally, in accordance with the present invention, said step of washing further includes the steps of: wetting with running water; scrubbing with rotating brushes and running water; and rinsing with running water.

Additionally, in accordance with the present invention, said step of scrubbing with rotating brushes and running water further includes scrubbing with soapy running water.

Additionally, in accordance with the present invention, said method includes rotating the brushes by the force of the running water.

Additionally, in accordance with the present invention, said method includes a step of massaging the body with rotating rollers.

Additionally, in accordance with the present invention, said method includes rotating the rollers by the force of the running water.

Additionally, in accordance with the present invention, said step of automatically adjusting individually adjustable, whole-body washing apparatus, responsive to said signals includes automatically adjusting the water temperature.

Additionally, in accordance with the present invention, said method includes drying the body with warm air.

Additionally, in accordance with the present invention, said step of automatically adjusting individually adjustable, whole-body washing apparatus, responsive to said signals includes automatically adjusting the air temperature.

### BRIEF DESCRIPTION OF THE DRAWINGS

The present invention will be more clearly understood from the accompanying detailed description and drawings, in which same number designations are maintained throughout the figures for similar elements and in which:

FIGS. 1A and 1B schematically illustrate individually adjustable, automated apparatus for washing generally the whole body of a person, in accordance with a preferred embodiment of the present invention;

FIGS. 2A-2D schematically illustrate a first system of running water and rotating brushes, in accordance with a preferred embodiment of the present invention;

FIGS. 3A-3D schematically illustrate three basic arrangements of apparatus 10, in accordance with the present invention;

FIGS. 4A-4E schematically illustrate a second system of running water and rotating brushes, in accordance with a preferred embodiment of the present invention;

FIG. 5 schematically illustrates the operation of a rotating brush, in accordance with a preferred embodiment of the present invention;

FIGS. 6A-6C schematically illustrate water, soap and air delivery systems, in accordance with a preferred embodiment of the present invention;

FIG. 7 is a flow chart which summarizes the process of massaging and washing with individually adjustable, automated apparatus, for washing the body

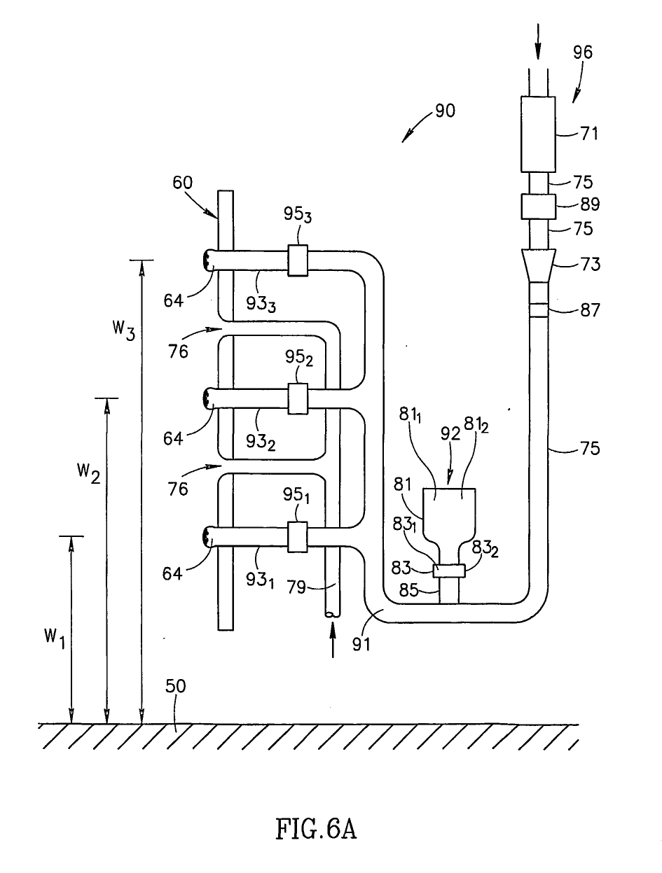

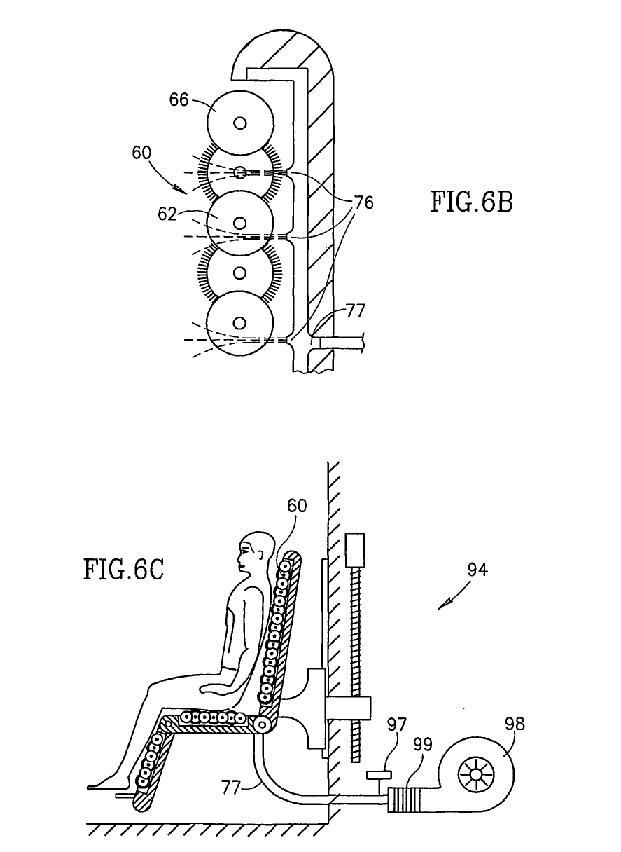

FIGS. 6A-6C schematically illustrate water, soap and air delivery systems, in accordance with a preferred embodiment of the present invention;

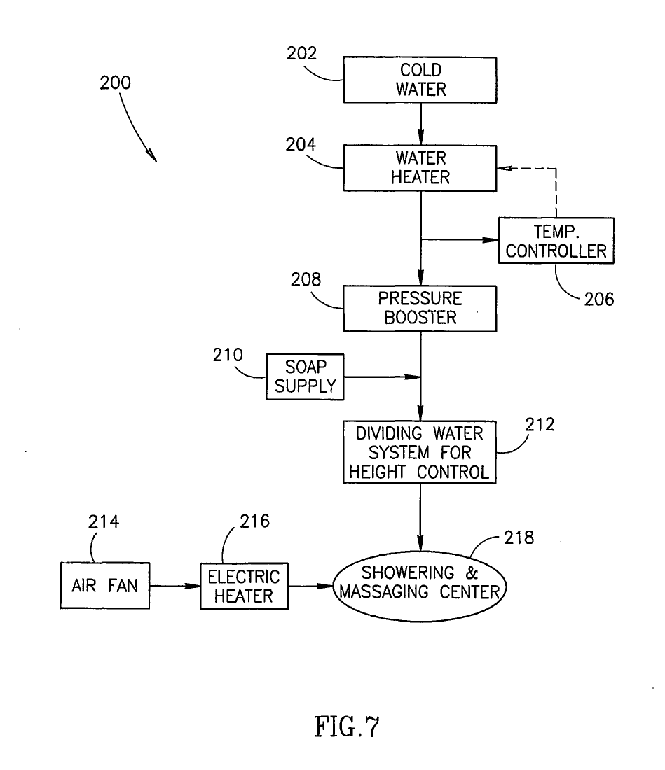

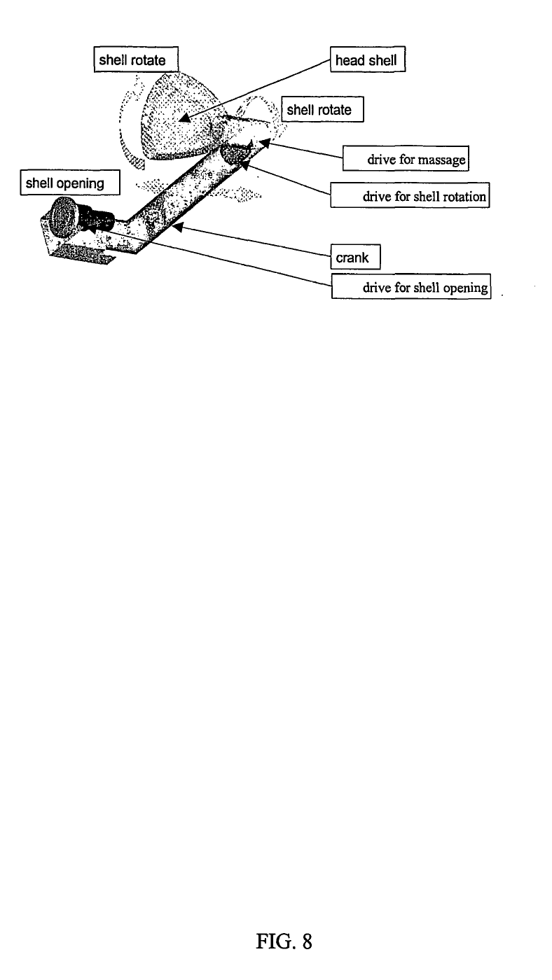

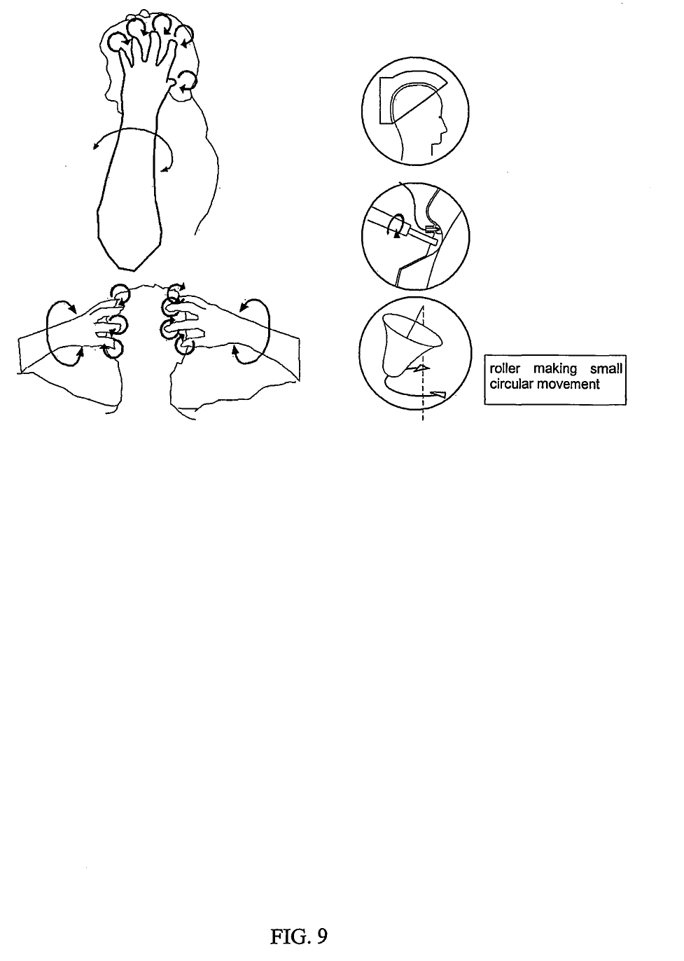

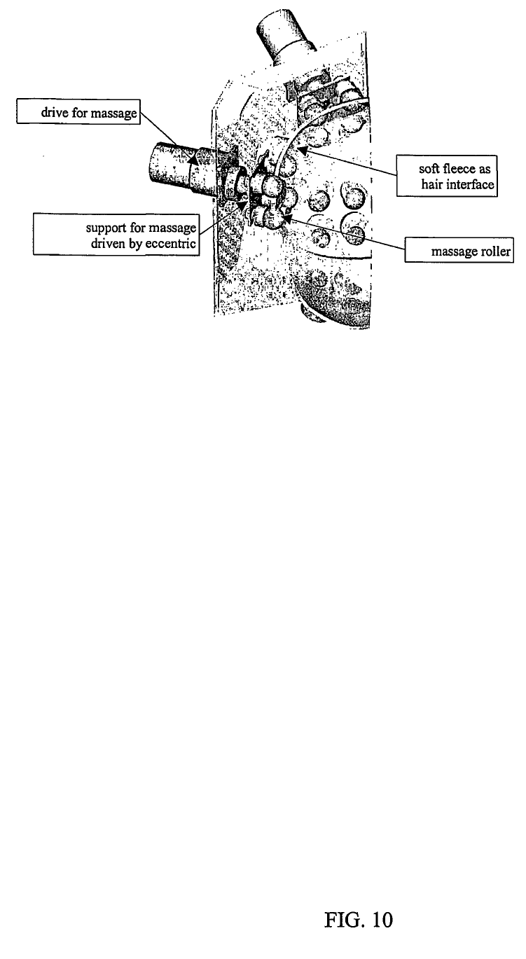

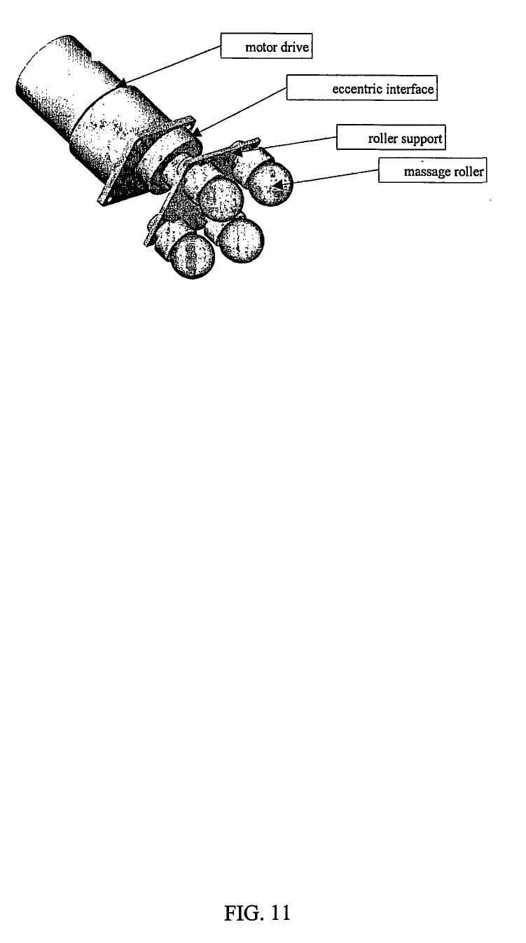

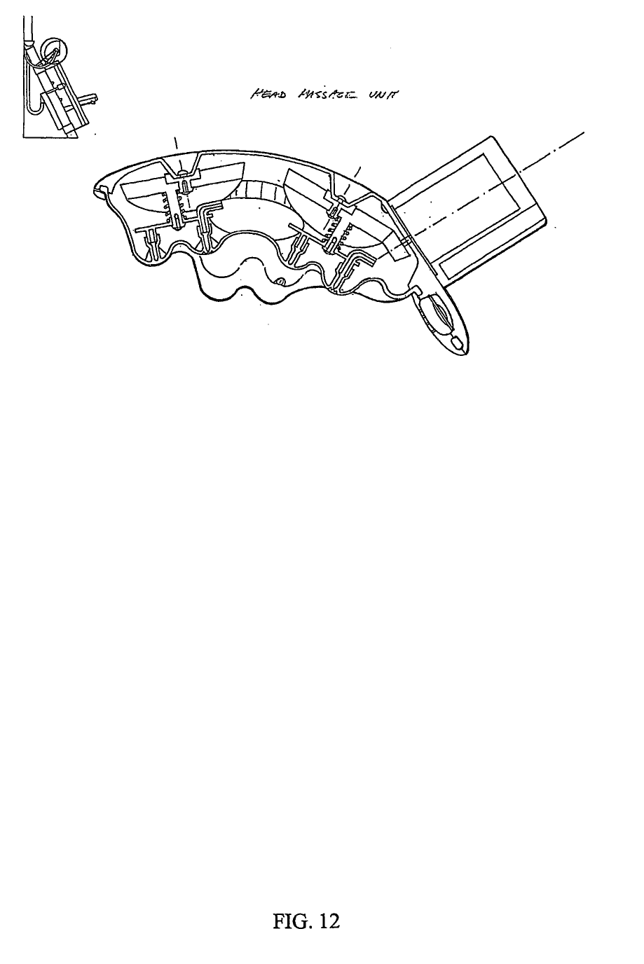

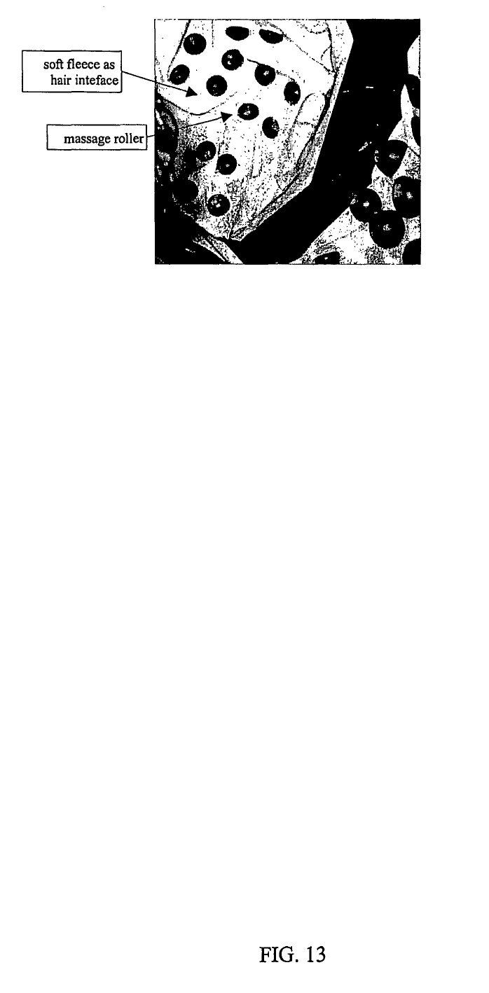

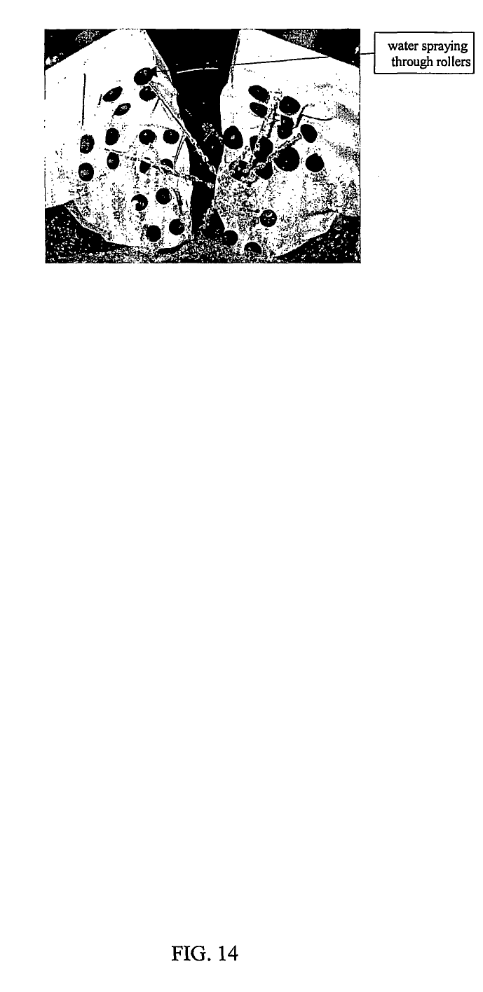

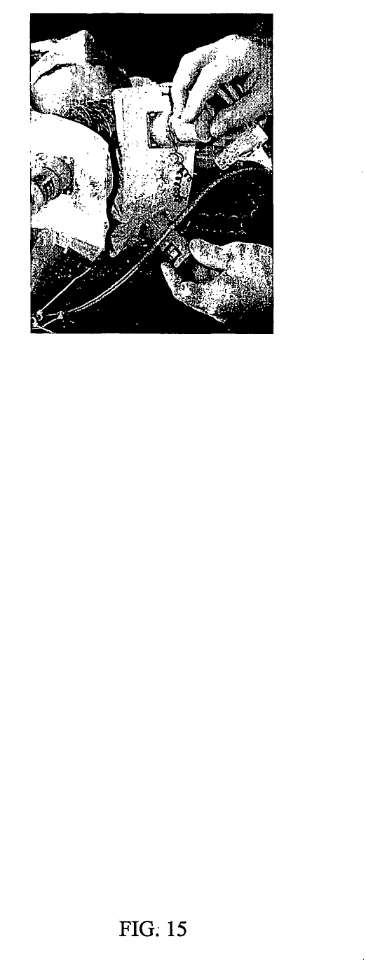

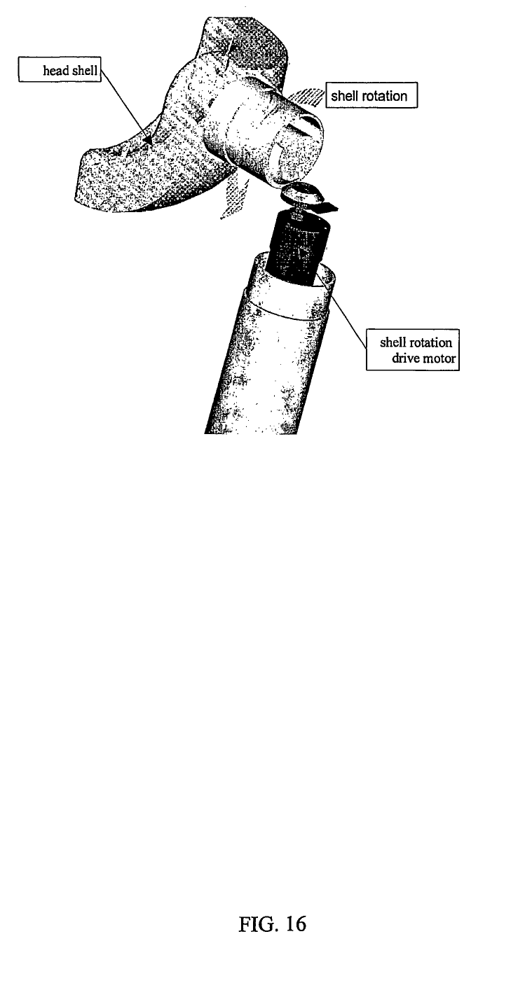

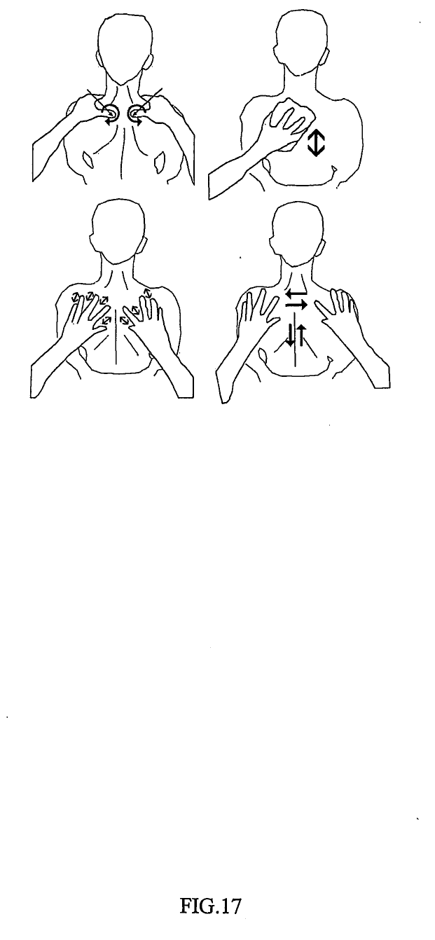

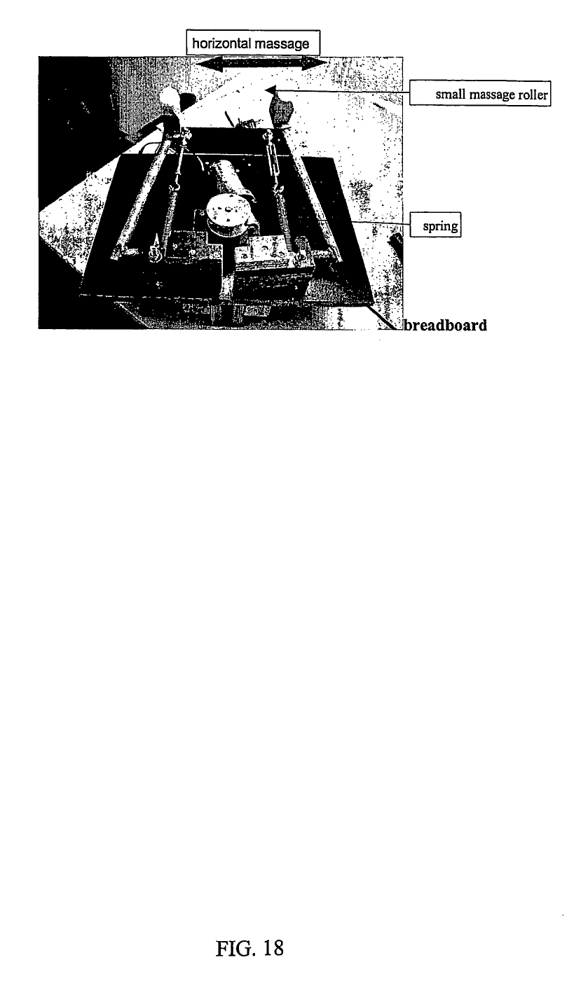

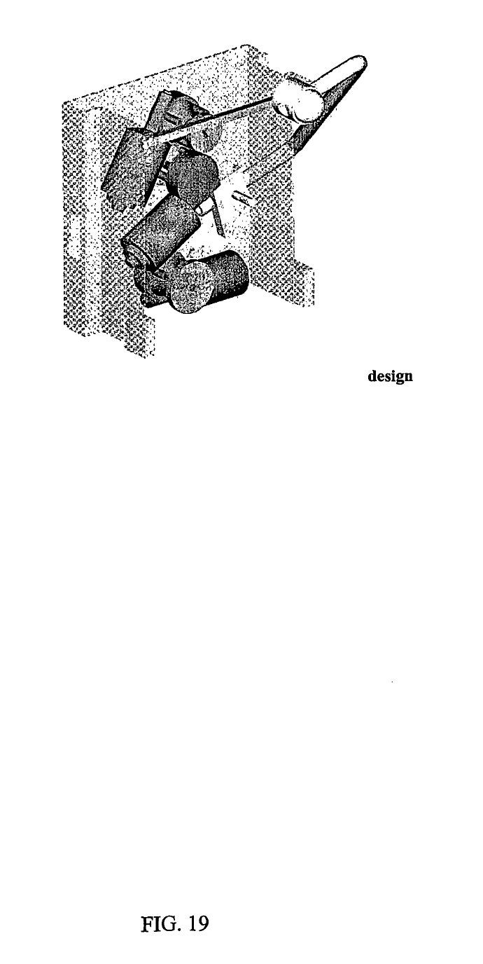

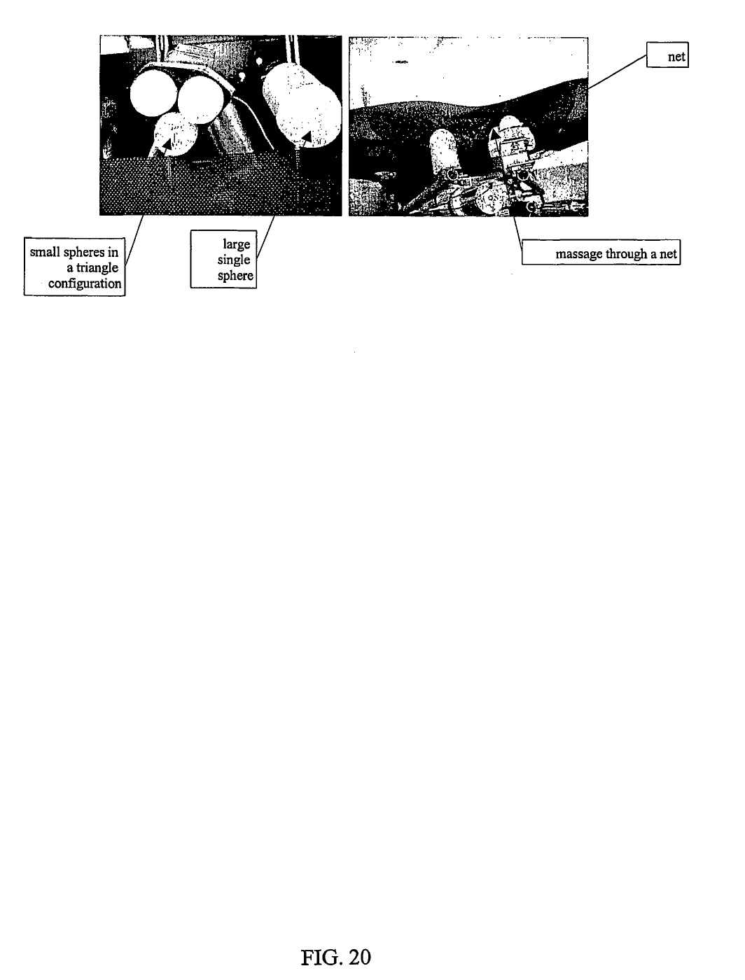

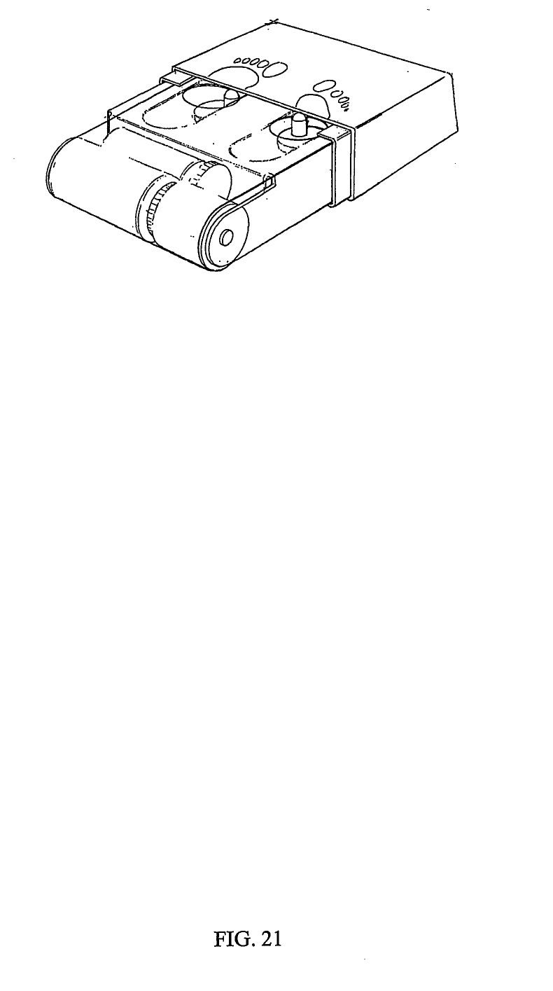

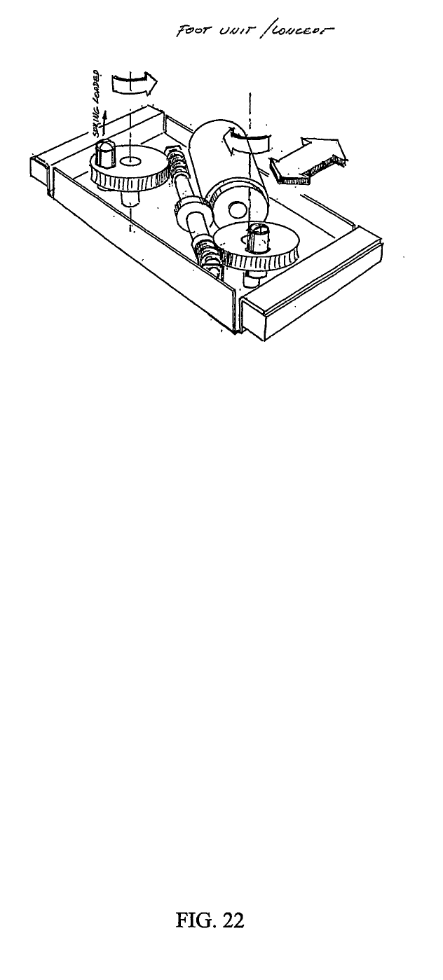

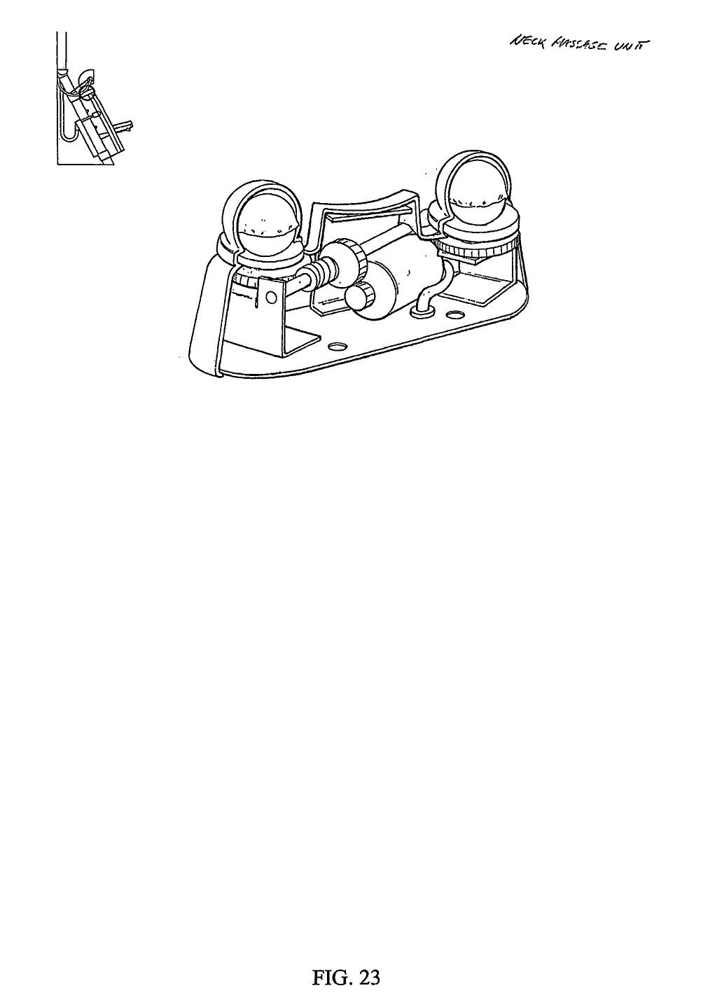

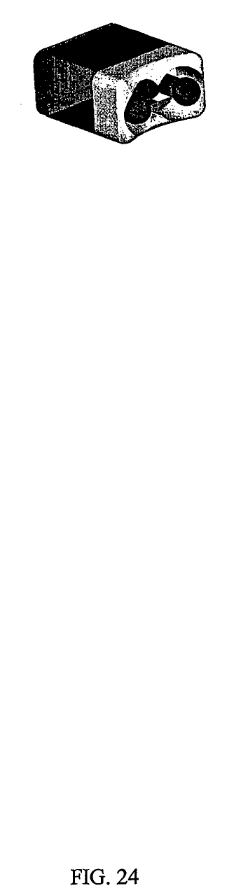

FIG. 7 is a flow chart which summarizes the process of massaging and washing with individually adjustable, automated apparatus, for washing the body of a person, in accordance with a preferred embodiment of the present invention; and

FIGS. 8-24 schematically illustrate operational units incorporating “ordinary” and preferred embodiments of the wash structure and its tactile member functionality therein.

### DETAILED DESCRIPTION OF EMBODIMENTS

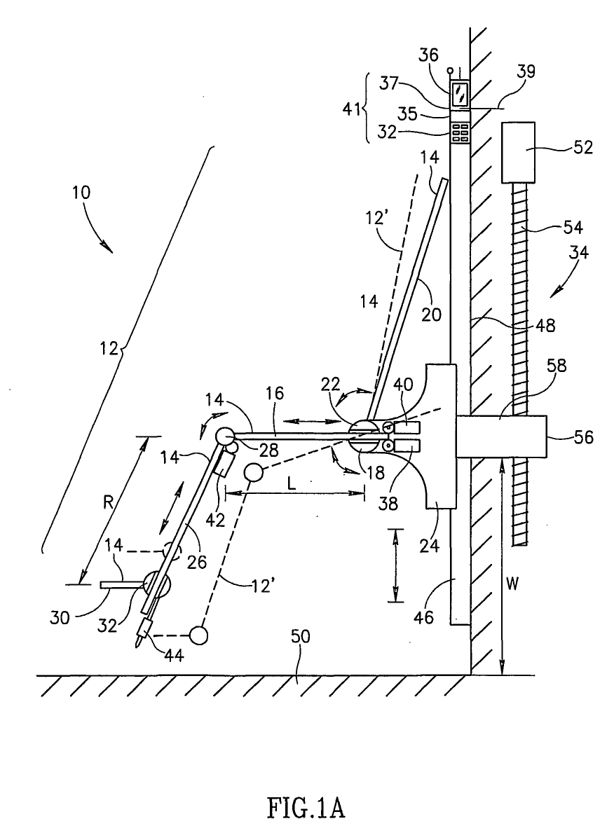

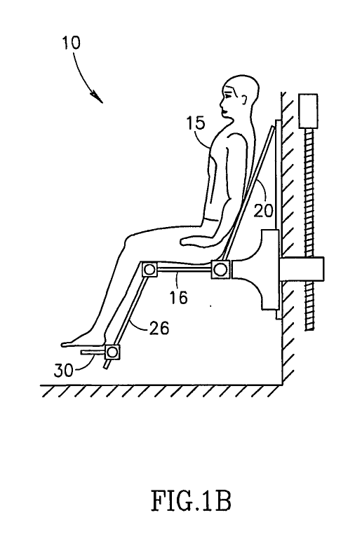

Reference is now made to FIGS. 1A and 1B, which together, schematically illustrate individually adjustable, automated apparatus 10, for washing generally the whole body of a person 15, in accordance with a preferred embodiment of the present invention. Preferably, apparatus 10 includes a wash structure 12 having a surface 14 arranged to be in contact with a portion of the body. Preferably, wash structure 12 is held by a block 24, of a support construction 34. Preferably, wash structure 12 includes the following components:

a. a generally horizontal seat 16, having a length L, which is preferably adjustable, by selectably sliding seat 16 via a slide mechanism 18;

b. a back support 20, having a length H, attached to seat 16 with a hinge 22, and arranged to selectably tilt with respect to seat 16;

c. a leg support 26, having a length R, which is preferably adjustable, attached to seat 16 with a hinge 28, and arranged to selectably tilt with respect to seat 16; and

d. a foot support 30, attached to leg support 26, with a slide mechanism 32, and arranged to selectably slide up and down along leg support 26.

Preferably, surface 14, which is in contact with the portions of the body to be washed, extends along back support 20, seat 16, leg support 26 and foot support 30.

Additionally, controller 36 is in communication with a drive 40, which provides tilting motion to back support 20, within hinge 22, for adjusting the tilt of back support 20.

Furthermore, controller 36 is in communication with a drive 42, which provides tilting motion to leg support 26, within hinge 28, for adjusting the tilt of leg support 26.

Additionally, controller 36 is in communication with a drive 44, which provides sliding motion to foot support 30, via slide mechanism 32, up and down along leg support 26, for adjusting the height of foot support 30.

Furthermore, controller 36 is in communication with a drive 52, which provides vertical motion to block 24 of support construction 34, for adjusting a height, W of seat 16 from a floor 50. Block 24 is arranged to slide in a vertical railing 46, which is attached to a wall 48. Preferably, block 24 includes an arm 58, having a threaded hole 56. Drive 52 turns a threaded rod 54, inside threaded hole 56 of arm 58, selectably moving block 24 up and down.

In accordance with an alternate embodiment of the present invention, block 24 itself has a threaded hole 56, and is arranged to move up and down along threaded rod 54, as motor 52 rotates rod 54, wherein motor 52 is attached to wall 48; railings 46 and arm 58 are not used.

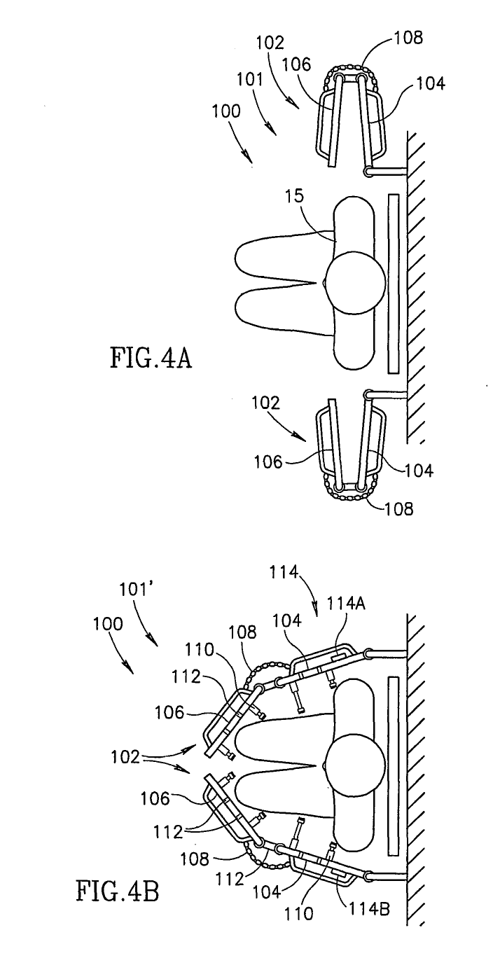

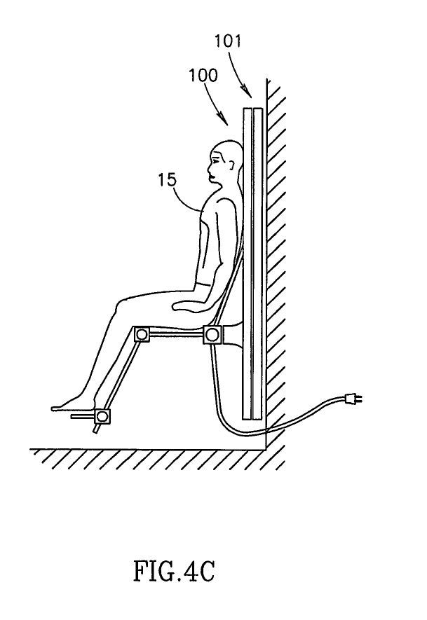

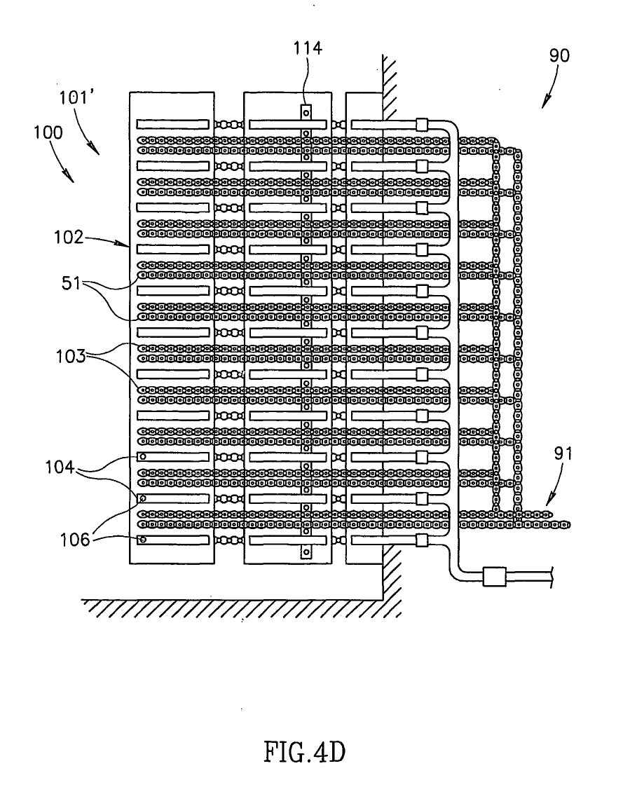

In accordance with an alternate embodiment of the invention, apparatus 10 further includes a head support (not shown), which is attached to back support 20, for example with hinge and slide mechanism, similar to hinge 22 and slide 18. The head support may be arranged as a tennis-racket frame, of an adjustable diameter, whose arm may slide in and out, to adjust for the height of person 15. The head support may be used with optical sensing system 114, described hereinbelow in conjunction with FIGS. 4B and 4D, to determine the neckline of person 15, for washing person 15 only from the neckline down.

Additionally, apparatus 10 may include a shampooing component (not shown), for example, as a system of nozzles and preferably circular flexible combs that is attached to the head support. Furthermore, apparatus 10 may include a hair-drying component attached to the head support.

FIG. 1A further illustrates wash structure 12 is an adjusted position 12′. In accordance with a preferred embodiment of the present invention, controller 36 is in communication with a smartcard reader 37. When a smartcard 39, which contains information about the needs and desires of person 15, is inserted to smartcard reader 37, controller 36 processes the information on it, and automatically adjusts apparatus 10 to accommodate the needs and desires of person 15. Alternatively, person 15 may communicate his needs and desires by voice command, to a microphone 31, or by key input via at least one key 33, or by touch, via a touch display panel 35, which may show a menu of the different adjustments. Controller 36, smart card reader 37, microphone 31, at least one key 33, and touch display panel 35 may be components of a computer 41 for controlling the operation and adjustments of apparatus 10, and may further include a memory unit 43.

Preferably, smart card 39 contains body dimensions of person 15, any limitations of person 15, desired water and air temperatures, as well as other desires, like bathing was no soap, or bathing with a strong rubbing motion. Alternatively, this information may be stored in memory unit 43, and may be referred to with a key stroke, or a vocal request.

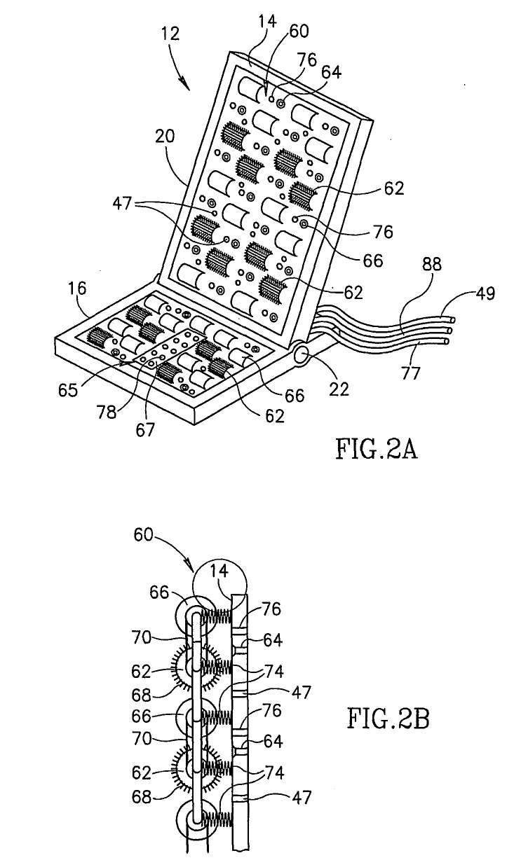

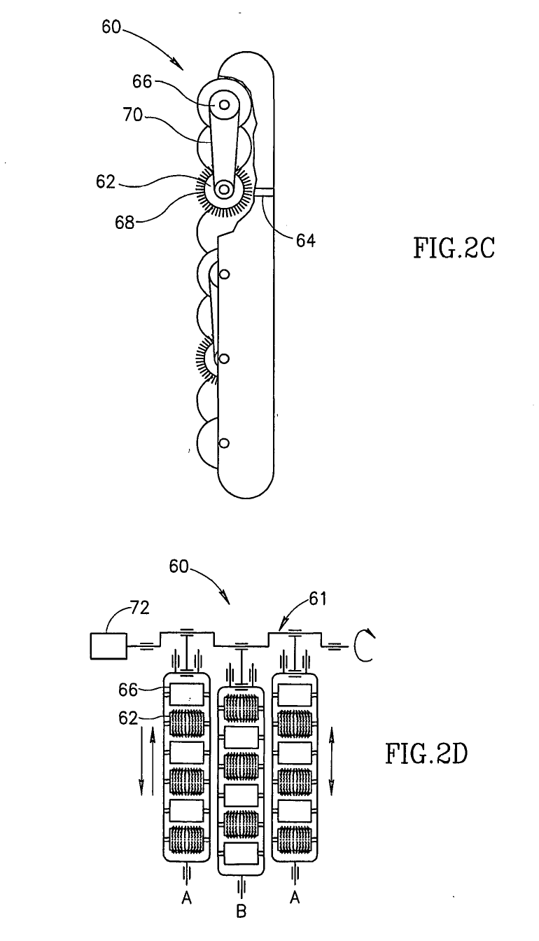

Reference is now made to FIGS. 2A-2D which together schematically illustrate a first system of running water and rotating brushes 60, imbedded in surface 14, of wash structure 12, in accordance with a preferred embodiment of the present invention. As illustrated in FIGS. 2A and 2B, surface 14 of wash structure 12 is formed of a plurality of water nozzles 64, for wetting and rinsing the portions of the body in contact with it, and rotating brushes 62, having whiskers 68, for scrubbing the portions of the body in contact with it. Additionally, first system 60 may include rollers 66, preferably formed of a soft elastomer, for massaging the portions of the body in contact with surface 14. Additionally, first system 60 may include warm air nozzles 76, for drying the body.

In accordance with a preferred embodiment of the invention, seat 16 includes an array of water nozzles 78 and an array of warm air nozzles 65 with no brushes 62 or rollers 66, serving as a bidet.

As seen in FIG. 2B, preferably, both brushes 62 and rollers 66 are attached to surface 14 of wash structure 12 by springs 74. When person 15 (FIG. 1A) leans against or seats on surface 14 of wash structure 12, springs 74 are in compression, ensuring that brushes 62 and rollers 66 are pressed against the body of person 15.

In accordance with a preferred embodiment of the present invention, illustrated in FIGS. 2C and 2D, a drive 72 provides the rolling motion for brushes 62 and rollers 66 as follows: brushes 62 and rollers 66 of first system 60 are arranged in rows, specific to each of back support 20, seat 16, leg support 26 and possibly also foot support 30. The rows along each are divided into groups A and B, and provided a cyclic motion, by drive 72 and a crank shaft 61, so that either rows of group A, or rows of group B are in contact with the body at any time. The oscillatory motion heightens the massaging effect of the brushes and rollers of first system 60. As drive 72 and crank shaft 61 provides motion to group A or B, the movement of rollers 66 against the body of person 15, leaning against it, causes rollers 66 to rotate.

Brushes 62 are in communication with rollers 66 through belts 70, thus rotating with rollers 66. In accordance with the preferred embodiment of the present invention, a transmission ratio different from 1:1 may be used, in order to create a rubbing effect.

Alternatively, as drive 72 and crank shaft 61 provides motion to rows of group A or B, the movement of brushes 62 against the body of person 15, leaning against it, causes brushes 62 to rotate, in a manner similar to the rotation of rollers 66. Different diameters of rollers 66 and bushes 62 may be used to cause rotational ratios different from 1:1.

Alternatively, any of brushes 62 and rollers 66 may be arranged to rotate by the force of the running water, like turbine wheels.

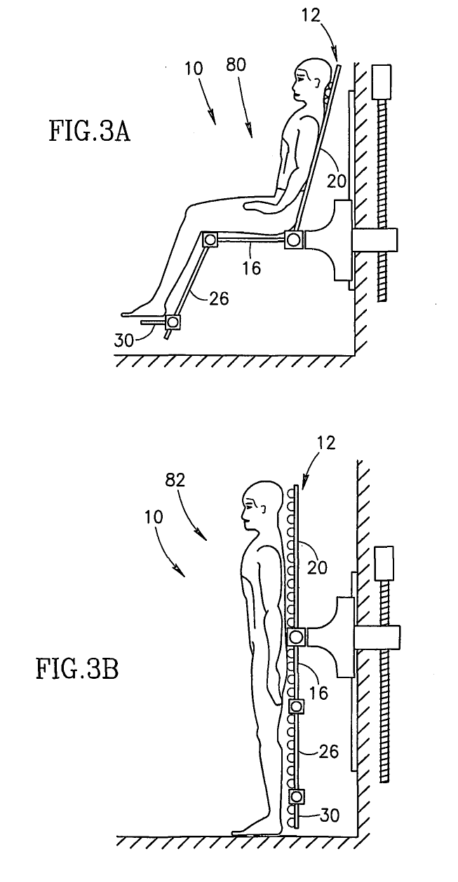

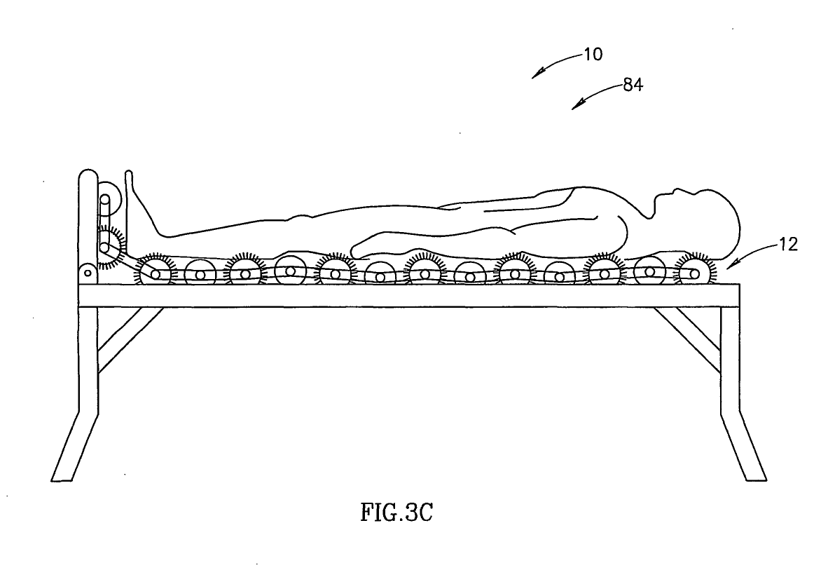

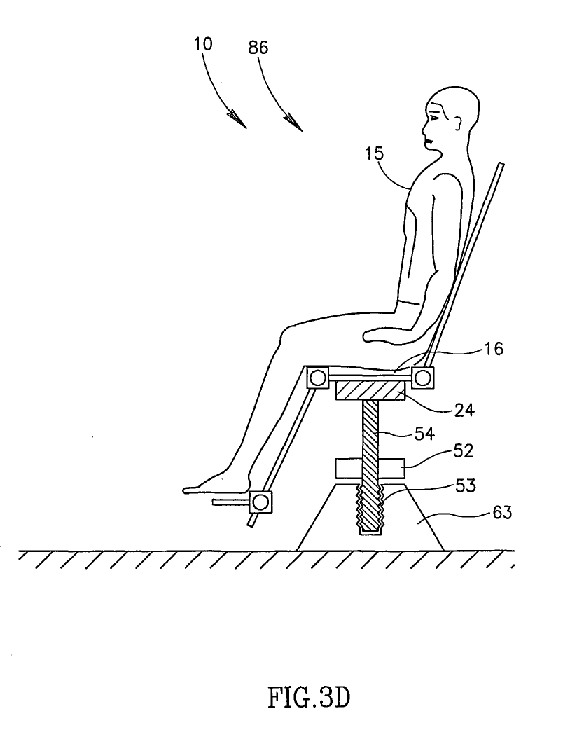

Reference is now made to FIGS. 3A-3D which together schematically illustrate basic arrangements of apparatus 10, in accordance with the present invention: a chair-like arrangement 80, illustrated in FIG. 3A, a vertical arrangement 82, illustrated in FIG. 3B, a bed-like arrangement 84, illustrated in FIG. 3C, and a portable arrangement 86, illustrated in FIG. 3D. Preferably, portable arrangement 86 is mounted on a tripod or a base 63, having a threaded hole 53, which compliments threaded rod 54. Threaded rod 54 supports block 24 which supports seat 16. Motor 52, attached to base 63 is operable to rotate rod 54, thus selectably raising and selectably lowering seat 16. Alternatively, any known base and jack mechanism may be used. Preferably, portable arrangement 86 may be opened up to any of chair-like arrangement 80, vertical arrangement 82, and bed-like arrangement 84, and may be folded into a carrying case 65, for easy transportation.

Reference is now made to FIGS. 4A-4E which together schematically illustrate a second system of running water and rotating brushes 100, of apparatus 10, in accordance with a preferred embodiment of the present invention. Second system 100 has a retracted position 101, seen in FIGS. 4A and 4C, and a deployed position 101′, seen in FIGS. 4B and 4D. Preferably, system 100 retracts and deploys as one unit.

Second system 100 includes a support structure 102, formed of a plurality of water pipes 104 and 106, which have elbows 108, formed of flexible pipes, for selectably retracting and selectably deploying second system 100. Pluralities of spray nozzles 112 and rotating brushes 110 are arranged along the lengths of pipes 104 and 106, for wetting, rinsing and scrubbing person 15.

As seen in FIG. 4D, a vertical optical sensing system 114 is used to determine the height of person 15 as he sits in apparatus 10. As seen in FIG. 4B, vertical optical sensing system 114, may be, for example, a vertical line light source 114A, and a vertical line light sensor 114B, arranged at the same height, and parallel with vertical line light source 114A. Light transmitted from line light source 114A, above the head of person 15 will reach line light sensor 114B. Light sensor 114B is in communication with controller 36, for reporting the height of person 15 as he sits in apparatus 10. Controller 36 may use this information in adjusting apparatus 10 to person 15.

Additionally, as seen in FIGS. 4D and 4E, support structure 102 includes a plurality of flexible, preferably bellows-shaped, warm air pipes 103, each having a plurality of air nozzles 105, for blowing warm air on person 15, for drying.

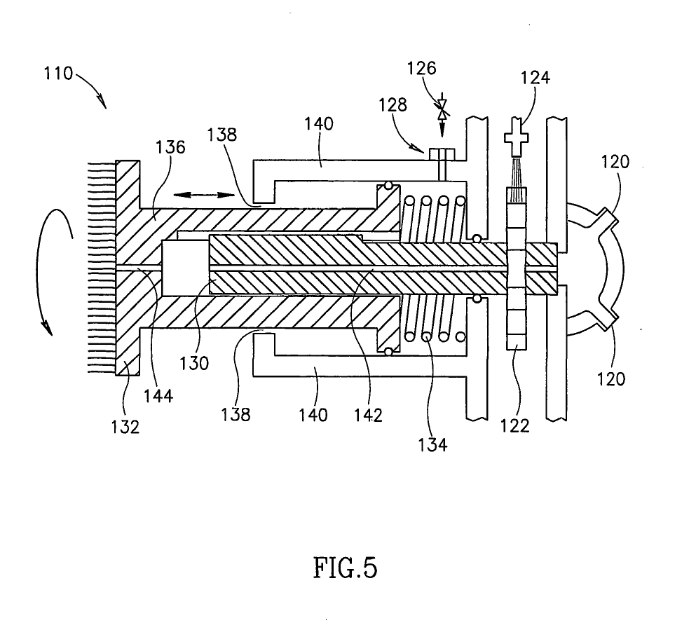

Reference is now made to FIG. 5, which schematically illustrates the operation of rotating brush 110, made to rotate by the force of running water, in accordance with a preferred embodiment of the present invention. Brush 110 includes a brush frame 140, a brushing component 132, and an arm 136, by which brushing component 132 is attached to frame 140. Brush 110 further includes a spring 134, internal to frame 140, located at its base. Brush 110 has a retracted position, wherein, arm 136 of brushing component 132 is pressed against spring 134, and a deployed position, wherein, arm 136 is extended, via a sliding component 138.

Water entering brush 110 from at least one water inlet 124, forces a turbine 122 to rotate, causing an axle 130, in communication with arm 136, to rotate, thus rotating arm 136 and brushing component 132.

Additionally, water entering from at least one water inlet 128, into the inner space of frame 140, pushes arm 136 out of frame 140, through sliding component 138, deploying brush 110. Preferably, brush 110 may be deployed to the point of contact with person 15 (FIG. 1A), for scrubbing person 15.

Furthermore, water entering from at least one water inlet 120, via a channel 142 within axle 130, flows further through a channel 144 in brushing component 132, for wetting and rinsing person 15.

Preferably, at least one water inlet 128 has an electronic valve 126, which may be controlled by controller 36, thus controlling the pressure by which brush 110 presses against person 15.

Similarly, electronic valves 126 may be used at water inlets 120, and 124, for controlling the water flow rate through brush 110, and the rotational speed of brush 110.

Reference is now made to FIG. 6A-6C, which together, schematically illustrate a delivery system 90, which includes a water delivery system 96, a soap delivery system 92, and a warm-air delivery system 94, in accordance with a preferred embodiment of the present invention.

As seen in FIG. 6A, water delivery system 96 includes a water heater 71 and a thermostat 89, both in communication with controller 36, for controlling the water temperature. Additionally, water delivery system 96 includes a water pressure booster 73, and an electronic valve 87, both in communication with controller 36, for controlling the water flow rate. Furthermore, water delivery system 96 includes a water inlet line 91, leading from valve 87 to first and second running water and rotating brushes systems 60 and 100.

Water inlet line 91 branches to a plurality of water pipes 93ᵢ, such as 93₁, 93₂, 93₃, each supplying water to apparatus 10 at a given height, wᵢ such as w₁, w₂, w₃, from floor 50. Electronically controlled valves 95ᵢ, such as 95₁, 95₂, 95₃, associated with water pipe 93ᵢ and height from floor 50, wᵢ, control the flow of water in each of water pipes 93ᵢ. This arrangement allows person 15 (FIG. 1A) to wash only selective parts of his body, such as only the legs, or only the lower body, or only the torso, or only from the neck down. In particular, valves 95ᵢ may be used in conjunction with information received by controller 36 from optical sensing system 114 with regard to the height of person 15, for allowing water to flow only in water pipes 93ᵢ of a specific height in relation to the height of person 15, when sitting in apparatus 10.

Soap delivery system 92 includes a liquid soap container 81, an electronic valve 83, which may be used by controller 36, for selectably washing with no soap, with little soap, or with much soap, and a soap inlet line 85 that feeds water inlet line 91 with liquid soap.

As seen in FIGS. 6B and 6C, warm-air delivery system 94 includes an air blower 98, in communication with an electric heater 99, whose operation may be controlled by controller 36, and a thermostat 97. The warm air flows via air line 77 and through air nozzles 76.

Reference is now made to FIG. 7, which is a flow chart 200, summarizing the process of massaging and washing with individually adjustable, automated apparatus, for washing the body of a person, in accordance with a preferred embodiment of the present invention. In a box 202, cold water enters the apparatus. In a box 204, the water is heated. In a box 206, water temperature is measured, and a feedback is sent to the water heater to adjust the water temperature.

In a box 208, water pressure is boosted, in a box 210, soap is added to the water, and in a box 212, the water is distributed to a plurality of water pipes of first and second systems 60 and 100. In ellipse 218, washing takes place.

Additionally, in boxes 214 and 216, an air blower blows, in communication with an electric heater, blow warm air, for a drying operation.

The present invention also relates to preferred embodiments of an individually adjustable, automated, washing apparatus, which includes: (A) a controller that is arranged for receiving input to a program of at least two steps, each said step having a plurality of variables selected from the list temporal aspect, frequency aspect, cyclic aspect, temperature preference aspect, and at least one temperature limit aspects, and the controller transforms the input into a series of control signals; (B) a wash structure that is held by a support construction, and the wash structure includes a surface, in contact with a portion of a person to be washed, and this surface has a first system of running water and tactile stimulus members, and the first system of water and tactile stimulus members is imbedded in said surface, and is in communication with a water source, and the first system is responsive to the signals; and (C) at least one driver of motion of the members, and the at least one driver is driven by at least one item selected from the list: electromechanical motors, water pressure, air pressure, and a pressurized air-water-mixture.

According to some variations of these preferred embodiments, the tactile stimulus members are selected from the list: brushes, rollers, finger-like projections, rolling spheres, or operational pressures of water, air or other mixtures as they are forced out from nozzles—and are thereby performing tactile stimulus functions.

According to some other variations of these preferred embodiments, the input relates to an elective aspects of water use having an addition selected from the list soap, conditioner, oils, perfumes, mixtures with air.

According to some further variations of these preferred embodiments, the input relates to at least one absolute limitation; so as to preclude the controller from configuring a combination of variables that is liable to injure or otherwise adversely wash or stimulate the human body or body part intended for washing.

According to some different variations of these preferred embodiments, the wash structure includes a drive, for adjusting said wash structure, responsive to signals from said controller.

According to still other variations of these preferred embodiments, the wash structure includes a second system of running water and tactile stimulus-like members, in communication with a water source, for washing the portions of the body that are not in contact with said members.

Turning now to FIGS. 8-24, representing some of these preferred embodiments of wash structure apparatus incorporated into the present invention; including descriptions of Head massage with shampoo dispensing, Back massage movements, Back massage drive mechanism, Back massage roller, Foot massage, and Lower neck massage. Substantially these figures relate to modular portions of the wash structure as can be applied individually or in combination.

Head massage with shampoo dispensing embodiment relates to a head unit with three functions: (1) massaging the head and (2) washing and (3) drying the hair—as seen in FIGS. 8-16

Head massage: The head is massaged by small soft finger-like nipples (“rollers” or tactile members). The rollers are rolling over the skin of the head and are making small circular movements, because they are driven by a ball hinge, which is eccentrically mounted onto a drive, thus providing the small circular movements. In the center of the roller is a small opening, which is used for shampoo and water addition. The rollers are configured in groups of four and mounted on a spring loaded support drive. The springs provide a radial degree of freedom (relative to the center of the head), thus allowing a substantially perfect fit to any shape of head. Three sets of four rollers make one shell, which covers one side of the head (one shell left and one shell right). The shells can rotate from back to front and vice versa, allowing a complete coverage of ones head. The shells are spring loaded according to a horizontal axis, so the user doesn't have a feeling of getting stuck.

Hair wetting and rinsing: With the shells in opened position and the rollers still making circular movements, water is sprayed through the rollers onto the hair.

Shampoo dispensing: The user puts a portion of his own shampoo in a conical reservoir. Shampoo is sucked in out of the bottom of the reservoir by a peristaltic pump, allowing a good quantity control. The shells are in closed position (in contact with the hair) and the rollers are still making circular movements to allow a good shampoo distribution. The peristaltic pump pushes the shampoo through the rollers onto the hair.

Head washing: With the shells in closed position, the rollers make circular movements, thus massaging the head and washing the hair.

Substantially “Small circular movements emulate the preferred massaging concept using the above described Massage rollers and a controller for a drive mechanism including Hair wetting and rinsing, Rotation of shell—massage of the head in a rotating shell; and Shampoo dispensing system—transport of small amounts of shampoo from an open reservoir to the users head by use of a peristaltic pump.

Back massage: Recall, the input to the controller relates to a program of at least two steps each having a plurality of variables and expressing thereby aspects concerning individual form, needs and desires; such as temporal aspects of each step, frequency aspects of any variable within a step, cyclic aspects of any step or plurality of steps, and aspects of temperature preference and temperature limits. The back massage unit has one dominant function: massaging a users back; which may be used independently or as one of the functions in the context of the controller program. The system is built up as follows: massage of the back through a net with rolling spheres driven by a crank mechanism spring loaded and thus automatically adapting to the shape of the users body allowing horizontal and vertical movements and a combination giving circular patterns Back massage movements horizontal and vertical movements and a combination giving circular patterns.

TURNING TO FIGS. 17-24—Back massage drive mechanism rolling spheres (rolling like a ball joint) driven by a crank mechanism spring loaded and thus automatically adapting to the shape of the users body. Back massage roller rolling spheres (rolling like a ball joint)—eccentric driving mechanism of the rolling spheres to massage the foot. Lower neck massage: neck massage by spheres making circular movements driven by an eccentric drive.

The present invention also relates to software and to memory media recording that software—both of which are associated with the controller.

It will be appreciated by persons skilled in the art, that the scope of the present invention is not limited by what has been specifically shown and described hereinabove; which is merely by way of example.

1. Individually adjustable, automated, washing apparatus, which includes:
a. a controller, arranged for receiving input concerning individual form, needs and desires of a person to be washed and for processing said input;
b. a wash structure, held by a support construction, said wash structure including: a drive, for automatically adjusting said wash structure, responsive to signals from said controller; a surface, in contact with a portion of the person to be washed; and a first system of running water and tactile members, imbedded in said surface, in communication with a water source, for washing the portion of the person in contact with said surface.

2. Apparatus according to claim 1, wherein said first system includes a second system of running water and tactile members, anchored against said wash structure, in communication with a water source, for washing the portions of the body not in contact with said surface.

3. Apparatus according to claim 1, wherein said apparatus is portable, and is arranged to be folded into a carrying box.

4. Apparatus according to claim 1, wherein said wash structure automatically adjusts to an arrangement selected from a group which consists of:
a. a generally vertical arrangement, for washing the body of the person, standing against it;
ii. a bed-like arrangement, for washing the body of the person, lying on it; and
iii. a chair-like arrangement, for washing the body of the person, sitting on it.

5. Apparatus according to claim 1, wherein electronically controlled valves automatically prevent washing by said first and second systems above a certain height in relation to the height of the person responsive to input from an optical sensing system with regard to the height of the person.

6. Apparatus according to claim 1, wherein said wash structure further includes a head support.

7. Apparatus according to claim 6, wherein said head support further includes a shampooing system.

8. Apparatus according to claim 6, wherein said head support further includes a head blow-drying system.

9. Apparatus according to claim 1, wherein said first system of running water and tactile members includes both water nozzles and rotating brushes.

10. Apparatus according to claim 1, wherein said first system of running water and tactile members is arranged to move the members by the force of the running water.

11. Apparatus according to claim 1, wherein said first system of running water and tactile members further includes a system of rotating rollers for massaging the portion of the body in contact with said surface.

12. Apparatus according to claim 1, wherein said first system of running water and tactile members further includes a warm-air blower for drying the portion of the body in contact with said surface.

13. A method of washing a whole body portion of a person, which includes the steps of:
a. receiving input concerning individual form, needs and desires of the person;
b. processing said input;
C. producing signals which correspond to said input;
d. automatically adjusting individually adjustable, whole-body washing e. apparatus, responsive to said signals; and
f. washing the whole body portion of the person in accordance with said input.

14. Individually adjustable, automated, washing apparatus, which includes:
(A) a controller that is arranged for receiving input to a program of at least two steps, each said step having a plurality of variables selected from the list temporal aspect, frequency aspect, cyclic aspect, temperature preference aspect, and at least one temperature limit aspects, and the controller transforms the input into a series of control signals; (B) a wash structure that is held by a support construction, and the wash structure includes a surface, in contact with a portion of a person to be washed, and this surface has a first system of running water and tactile stimulus members, and the first system of water and tactile stimulus members is imbedded in said surface, and is in communication with a water source, and the first system is responsive to the signals; and (C) at least one driver of motion of the members, and the at least one driver is driven by at least one item selected from the list: electromechanical motors, water pressure, air pressure, and a pressurized air-water-mixture.

15. The apparatus according to claim 14 wherein the tactile stimulus members are selected from the list: brushes, rollers, finger-like projections, rolling spheres, or operational pressures of water, air or other mixtures as they are forced out from nozzles—and are thereby performing tactile stimulus functions.

16. The apparatus according to claim 14 wherein the input relates to an elective aspects of water use having an addition selected from the list soap, conditioner, oils, perfumes, mixtures with air.

17. The apparatus according to claim 14 wherein the input relates to at least one absolute limitation; so as to preclude the controller from configuring a combination of variables that is liable to injure or otherwise adversely wash or stimulate the human body or body part intended for washing.

18. The apparatus according to claim 14 wherein the wash structure includes a drive, for adjusting said wash structure, responsive to signals from said controller.

19. The apparatus according to claim 14 wherein the wash structure includes a second system of running water and tactile stimulus-like members, in communication with a water source, for washing the portions of the body that are not in contact with said members.
